(19) United States
(12) Patent Application Publication
(10) Pub. No.: US 2008/0169163 A1
(43) Pub. Date: Jul. 17, 2008

(54) HARMONIC DAMPENER

(76) Inventor: Mark William Davis, Edmonton (CA)

Correspondence Address: DAVIS BUJOLD & Daniels, P.L.L.C., 112 PLEASANT STREET, CONCORD, NH, 03301, US

(21) Appl. No.: 11/861,367

(22) Filed: Sep. 26, 2007

(30) Foreign Application Priority Data
Jan. 17, 2007 (CA) 2 575 089

(51) Int. Cl. F16F 7/116; F16F 7/112

(52) U.S. Cl. 188/269; 188/380

(57) ABSTRACT

A harmonic dampener includes a first body having an internal cavity. A first mounting is provided on the first body. An elongated second body is telescopically received within the internal cavity of the first body. Dampening means are positioned within the internal cavity of the first body and adapted to dampen telescopic movement of the second body relative to the first body. A second mounting is provided on the second body. The second mounting is a slot adapted to receive a mounting pin. The slot defines a free travel limit for the mounting pin. Movement of the mounting pin within the slot caused by vibrations and oscillations does not energize the dampening means unless such movement exceeds the free travel limit defined by the slot.

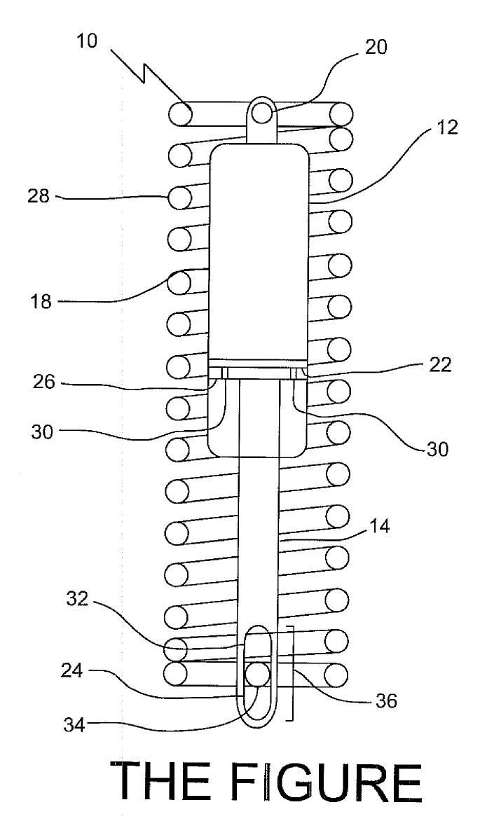

### FIELD

The present invention relates to a harmonic dampener, such as may be used with a vehicle wheel to reduce the magnitude of vibrations transmitted to the vehicle.

### BACKGROUND

Shock absorbers are presently subject to continuous “chatter” caused by vibrations and oscillations. When used with a vehicle wheel, this chatter reduces the smoothness of the ride as experience by an occupant of a vehicle. This same chatter diminishes the effectiveness of the shock absorber in other applications.

### SUMMARY

There is provided a harmonic dampener which includes a first body having an internal cavity. A first mounting is provided on the first body. An elongated second body is telescopically received within the internal cavity of the first body. Dampening means are positioned within the internal cavity of the first body and adapted to dampen telescopic movement of the second body relative to the first body. A second mounting is provided on the second body. The second mounting is a slot adapted to receive a mounting pin. The slot defines a free travel limit for the mounting pin. Movement of the mounting pin within the slot caused by vibrations and oscillations does not energize the dampening means unless such movement exceeds the free travel limit defined by the slot.

### BRIEF DESCRIPTION OF THE DRAWINGS

These and other features will become more apparent from the following description in which reference is made to the appended drawings, the drawings are for the purpose of illustration only and are not intended to in any way limit the scope of the invention to the particular embodiment or embodiments shown, wherein:

THE FIGURE is a side elevation view in section of a harmonic dampener.

### DETAILED DESCRIPTION

A harmonic dampener generally identified by reference numeral 10, will now be described with reference to THE FIGURE.

Structure and Relationship of Parts:

A harmonic dampener 10 is detailed in THE FIGURE. Harmonic Dampener 10 has a resilient body, such as spring 28, and a dampening means. Spring 28 is designed to be connected between two bodies that move away from and toward each other, such as the frame of a vehicle, and the wheel of the vehicle (not shown). The dampening means is also designed to be connected between the two bodies, and is used to dampen the oscillations of spring 28. In the depicted example, the dampening means is a hydraulic dampener 11 that has a first portion 12 and an elongated second portion 14. First portion 12 has an internal cavity 18 and a first mounting 20. First mounting 20 may be attached to a first body, such as the frame of a vehicle (not shown). Elongated second portion 14 is telescopically received within internal cavity 18 of first portion 12. Elongated second portion 14 has a first end 22 and a second mounting 24. First end 22 may function like a piston 26 within internal cavity 18 to dampen oscillations. In the depicted example, first end 22 contains fluid ports 30 that allow hydraulic fluid to flow through first end 22. Alternatively, other conventional dampening means may be used. The most common conventional dampening means include pneumatic dampening mediums, hydraulic dampening mediums and mechanical dampening mediums. Second mounting 24 is a slot 32, adapted to receive a mounting pin 34. Slot 32 defines a free travel limit 36 for mounting pin 34. Mounting pin 34 may be attached, directly or indirectly to the wheels (not shown) of a vehicle. The dampening means should have sufficient resistance to movement to maintain the relative position of first portion 12 and elongated second portion 14.

Operation:

When the two bodies are stationary relative to each other, mounting pin 34 will maintain its position within slot 32. As the two bodies move relative to each other, mounting pin 34 will also travel within slot 32. Mounting pin 34 will only engage the top or bottom of slot 32, and thus energize hydraulic dampener 11, for oscillations of a certain size. Thus, during operation of the vehicle, the operation of harmonic dampener 10 will result in mounting pin 34 being generally centrally positioned as smaller vibrations due to “road rumble” cause it to establish an upper and lower travel limit, such as plus or minus 1 cm within slot 32. This means that movement of second body 14 relative to first body 12 will not be required for most minor bumps, oscillations and vibrations, which are absorbed and dissipated by spring 28 alone. Fluid ports 30 allow hydraulic fluid to flow through first end 22 of elongated second body 14 when elongated second body 14 is forced to move relative to first body 12.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. A harmonic dampener, comprising:
a resilient body connected between a first body and a second body, the resilient body resisting movement of the second body toward or away from the first body;
a dampening means connected between the first body and the second body for dampening oscillations of the resilient body, the second body having a mounting pin, the dampening means having a slot connection for receiving the mounting pin, the slot defining a free travel limit for the mounting pin such that the dampening means is not energized unless movement of the mounting pin within the slot exceeds the free travel limit, the dampening means having an internal friction such that the dampening means remains stationary unless energized.

2. The harmonic dampener of claim 1, wherein the resilient body is a coil spring.

3. The harmonic dampener of claim 1, wherein the dampening means is one of a pneumatic dampening medium, a hydraulic dampening medium or a mechanical dampening medium.
